(19) United States
(12) Patent Application Publication
(10) Pub. No.: US 2015/0142765 A1
(43) Pub. Date: May 21, 2015

(54) SYSTEM AND METHOD FOR ENABLING REMOTE FILE ACCESS VIA A REFERENCE FILE STORED AT A LOCAL DEVICE THAT REFERENCES THE CONTENT OF THE FILE

(71) Applicant: ZHEN-CHAO HONG, New Taipei (TW)

(72) Inventor: ZHEN-CHAO HONG, New Taipei (TW)

(21) Appl. No.: 14/487,117

(22) Filed: Sep. 16, 2014

Related U.S. Application Data
(60) Provisional application No. 61/905,197, filed on Nov. 17, 2013.
(60) Provisional application No. 61/905,198, filed on Nov. 17, 2013.

(51) Int. Cl. G06F 17/30

(52) U.S. Cl. CPC G06F 17/30097; G06F 17/30176
USPC 707/698

(57) ABSTRACT

A computing system may include multiple computing devices. A file at a computing device may be accessed based on a reference file stored at the device that comprises a hash value of the content of the file. The hash value may be independent of the file location or file name and include a representation of the content of the file such that a given hash value is unique for given content. For example, the hash value may be generated using a hash function on the content of the file. The hash function may be generated by the hash function that reproducibly identifies the file based on the content of the file. In this manner, the reference file may be used to uniquely identify a file as well as serve as a basis for checking the integrity of files transmitted over a network from one computing device to another computing device.

### CROSS-REFERENCE TO RELATED APPLICATIONS

This application claims priority to U.S. Provisional Patent Application Ser. No. 61/905,197, filed on Nov. 17, 2013, and claims priority to U.S. Provisional Patent Application Ser. No. 61/905,198, filed on Nov. 17, 2013, both of which are incorporated by reference herein in their entireties. This application is related to co-pending U.S. patent application, entitled “,” SYSTEM AND METHOD FOR SYNCING LOCAL DIRECTORIES THAT ENABLE FILE ACCESS ACROSS MULTIPLE DEVICES filed concurrently herewith, which is incorporated by reference herein in its entirety.

### FIELD OF THE INVENTION

The invention relates to a system and method for enabling access to a file in a computing system that includes multiple computing devices, wherein a file is accessed based on a reference file stored at a computing device that comprises a hash value of the content of the file.

### BACKGROUND OF THE INVENTION

Generally speaking, a given user may use multiple computing devices for their computing needs and therefore may be associated with a set of different computing devices. For example, the set of computing devices may include a computing device dedicated to work, a mobile computing device, a tablet computing device, a smart phone, a personal computing device located in the individual's home, and/or other computing device. An individual may also have access, control, and/or other association with computing devices of other users, such as family members of the individual.

Each individual device in the set of computing devices may store a different set of files (including discrete types of different files, information, contact information, configuration settings, etc.), such that at least some files are stored in one computing device but not in another computing device. For example, a user's laptop computer may include a particular word processing document that is not stored on the user's smartphone. Therefore, accessing the word processing document from the user's smartphone may not be possible.

Conventional systems have been developed to enable remote access to files over a network. However, such conventional systems suffer from various limitations and drawbacks.

For example, a computing device of a conventional system of remote file access may reference a file based on a location at which the file is stored, regardless of whether the file is stored on the computing device or on another computing device. In particular, some conventional systems may reference a file based on its path name on a computing device such that the file may be obtained based on its path name. Other conventional systems may use a globally unique ID to reference a file and map the globally unique ID to a location of the file on a computing device. With these and other conventional systems, the reference to a file may fail in the event that the file is moved to another location.

Conventional systems suffer from these and other drawbacks.

### BRIEF SUMMARY OF THE INVENTION

The invention solving these and other drawbacks of conventional systems relates to a system and method for enabling access to a file in a computing system that includes multiple computing devices, wherein a file is accessed based on a reference file stored at a computing device that comprises a hash value of the content of the file. The hash value may be independent of the file location or file name and include a representation of the content of the file such that a given hash value is unique for given content. For example, the hash value may be generated using a hash function on the content of the file. The hash function may be generated by the hash function that reproducibly identifies the file based on the content of the file. As such, unlike conventional file links and representations, even if the location or name of the file or reference file changes, the reference file may continue to be used to obtain the file. In this manner, the reference file may be used to uniquely identify a file (within the limits of such hash or similar functions) as well as serve as a basis for checking the integrity of files transmitted over a network from one computing device to another computing device.

In some implementations, a first computing device may store and display the reference file while a second computing device may store the file. The second computing device may also store or otherwise generate the reference file that corresponds to the file. In this manner, the first computing device may request the file from the second computing device by transmitting the reference file. Responsive to the request, the second computing device may compare the reference file received from the first computing device with its pre-stored version of the reference file, which may be associated with the file. The second computing device may identify the file based on the comparison (e.g., a match between the received reference file and its pre-stored version of the reference file) and provide the file (or portions of the file) to the first computing device. Because the reference file is generated based on the content of the file, even if the name or location of the file changes, the reference file may still be used to identify and obtain the file. Likewise, even if the name or location of the reference file changes, the reference file may be used to identify and obtain the file.

In some implementations, the reference file may be associated with a file name that is based on a file name of the file. For example, a given file name of a file may include an extension or other application identifier that indicates to an operating system an application used to open the file. A computing device that generates a reference file may add to the file name of the file an additional extension or other appendage that indicates that it is a reference file and use the appended file name to name the reference file. In this manner, whichever application is associated with the file may be launched to open the file when the file is obtained based on the reference file. Thus, the reference files described herein may be used at the file system level to identify/represent different types of files opened by different types of applications.

The reference files described herein may be used in various contexts. For example, the reference file may be used in association with a content provider who provides a reference file that when transmitted to the content provider causes the content provider to identify corresponding content and provide the content to a requesting computing device. In this manner, a computing device may download one or more reference files corresponding to content (e.g., videos, pictures, etc.) at the content provider and then later use a given reference file to download corresponding content from the content provider. Accordingly, the computing device need not download the entire content from the content provider, but rather only a reference file that corresponds to the content, thereby preserving disk or other storage space on the computing device while maintaining a list of selectable reference files that each correspond to content that may be later obtained from the content provider based on a selected reference file. As such, even if the name or location (e.g., Uniform Resource Locator (“URL”)) of the content is changed at the content provider, the reference file may still be used to identify and obtain the content, eliminating instances of broken URL and other links.

In other examples, the reference file may be used in association with a set of computing devices that is associated with a user, a family, an organization, a company, and/or other entity. Each computing device in the set of computing devices may store different files. For example, one computing device may store one file while another computing device may store another file. Instead of storing each of the files in all of the computing devices, a given computing device may simply store a reference file that corresponds to a file that is stored at another computing device. In this manner, a given computing device may request a file stored at another computing device by transmitting a reference file to the other computing device.

The set of computing devices may include one or more computing devices designated as a home computing device. The home computing device designation may be configured by the user of the set of devices such that the user may identify the one or more devices that are to serve as a home computing device.

The home computing device may be programmed to locally store (e.g., in an internal or external storage that is accessible to the home computing device) a set of the files that is available across the set of devices. For example, the home computing device may store a first file from a first computing device and a second file from a second computing device, where the first file is not stored on the second computing device and the second file is not stored on the first computing device. In some implementations, the home computing device may be programmed to store all of the files that are stored at all of the remote computing devices such that each file stored at any given device among the set of devices is stored locally at the home computing device. If the home computing device cannot store a given file (e.g., because the size of the file exceeds the storage capacity of the home computing device, is not network accessible, etc.), then the given file may be stored at a third party storage device, such as a cloud storage device. Such cloud storage may be temporary until the home computing device is able to store the file.

Each of the devices may be programmed to communicate an update to a file stored thereon to one or more of the other computing devices in the set of computing devices. The update may include an indication of a new file, a change to an existing file, a removal (e.g., deletion) of a file, and/or other changes to stored information . . . . For example, a given device may be programmed to identify a new file or reference file, changes to an existing file or reference file, a deleted file or reference file, file name changes, file location changes, and/or other changes related to files and reference files stored locally thereon. The given device may be programmed to communicate the update to the other devices in the set of devices. In some implementation, the given device may communicate the update to the home computing device, which propagates the update to the other devices. The home computing device may then make appropriate changes to its local copy of the file, and then cause similar updates to occur on the other computing devices. In some implementations, the given device may communicate the update to the other devices in a peer-to-peer, daisy-chain, and/or other configuration without using the home computing device as a coordinator of such updates.

Whichever technique of propagating the update is used, a given computing device among the set of devices may receive the update and act accordingly. In some implementations, the given computing device may determine whether to request from another computing device content related to the update. For example, if a new file is created at another computing device, the given computing device may receive a reference file corresponding to the new file. The reference file may be received from the home computing device, the computing device that generated the new file, and/or other computing device in the set of computing devices. The given computing device may determine whether to download the new file by transmitting a request that includes the reference file to one or more computing devices in the set or simply store the reference file only (which may be used to later obtain the new file on demand).

The determination of whether to request and store the new file or store only the reference file may be made based on one or more storage policies. A storage policy for an individual computing device may comprise, for example, a set of rules relating to the types of files that may be stored locally at the individual computing device. For example, the set of rules may comprise a first rule that files greater than a predetermined size may not be stored locally, a second rule that a predetermined amount of storage must be kept free at the local storage of the individual computing device, a third rule that only files accessed within a predetermined time period may be stored locally, and/or other rules related to the types of files that may be stored locally at the individual computing device. Thus, whether to obtain the new file may be based on the storage policy and associated rules.

Each computing device among the set of computing devices may be associated with its own storage policy. For example, a laptop computing device may be associated with a first storage policy while a tablet computing device may be associated with a second storage policy while still another computing device may be associated with a third storage policy, and so on. As such, one computing device may store a set of files and/or reference files that are different than the set of files and/or references files stored at another computing device.

Each individual computing device in the set of computing devices (e.g., the home computing device and/or other computing devices) may manage an individual reference directory. An individual reference directory of an individual computing device may comprise a representation of the files that are available across the set of devices. The representation of a file may comprise an indication of a file stored locally on the individual device, an indication of a reference file corresponding to the file, and/or other information related to the file.

In some implementations, a given computing device may store either the actual file or a reference file for the actual file for all of the files stored by the set of devices and accessible by the system. For example, a set of computing devices may include a first computing device that locally stores a first set of files and a second computing device that locally stores a second set of files. The first computing device may store at least some of the files of the second set of files and store any ones of the second set of files that are not stored at the first computing device as corresponding reference files. The second computing device may similarly store at least some of the first set of files and store other ones of the first set of files as corresponding reference files.

The first computing device may maintain and display in a first reference directory a listing of the first set of files, a listing of the second set of files that were downloaded, and a listing of reference files corresponding to any of the second set of files that were not downloaded. The second computing device may likewise maintain and display its own reference directory. The user may select a reference file in the first reference directory, which causes the first computing device to request a corresponding file from the second computing device by transmitting the selected reference file. The second computing device may respond by identifying the corresponding file based on the selected reference file and provide the corresponding file to the first computing device. The user may also select any of the actual files of the first set of files or downloaded ones of the second set of files, which causes the first computing to access the selected actual file from local storage. In this manner, files that are stored at different computing devices among a set of computing device programmed to interact with one another as described herein may be listed and accessed at any one of the computing devices.

In some implementations, a given computing device may update its reference directory based on updates received from the home computing device and/or other computing devices of the set of computing devices. In this manner, each of the reference directories may be synchronized with respect to one another. For example, a first computing device and a second computing device may store an actual file in a particular location of their corresponding reference directories (e.g., at a particular folder or other location within their reference directories). A third computing device may store a reference file corresponding to the actual file in the particular location of its reference directory.

If the actual file from the second computing device is moved to a particular location within the reference directory, the second computing device may cause the first computing device and the third computing device to be notified of the update as described herein. In response, the first computing device may change the location of its actual file to the particular location in its reference directory (creating the particular location/folder as necessary). Likewise, the third computing device may change the location of its reference file to the particular location in its reference directory. Other updates such as a file name change, addition of a file, deletion of a file, etc., may be likewise synchronized across each reference directory, providing a uniform user experience across all devices among the set of devices with respect to files that are available locally and/or remotely.

These and other aspects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a block diagram of an exemplary system for enabling remote file access across a computing system based on a hash value of the content of a requested file, according to various implementations of the invention.

FIGS. 2A, 2B, 2C and 2D illustrate a block diagram of an exemplary reference directory of a first computing device, second computing device, and third computing device, according to various implementations of the invention.

FIG. 3 illustrates a block diagram of an exemplary file stored across multiple devices of the computing system, according to various implementations of the invention.

FIG. 4 illustrates an exemplary process of accessing a file via a reference directory of a given computing device, according to various implementations of the invention.

FIG. 5 illustrates a data flow diagram of accessing a file in the computing system, according to various implementations of the invention.

FIG. 6 illustrates a black diagram of an exemplary system for creating reference files and accessing contents corresponding to reference files in the computing system, according to various implementations of the invention.

FIG. 7 illustrates a process for designating a computing device as a home computing device, according to various implementations of the invention.

FIGS. 8A, 8B, and 8C illustrate a block diagram of an exemplary reference directory of a home computing device, second computing device, and third computing device, according to various implementations of the invention.

FIG. 9 illustrates a process for changing a file at a computing device and syncing directories across the set of computing devices, according to various implementations of the invention.

FIGS. 10A, 10B, and 10C illustrate a block diagram of an exemplary reference directory of a home computing device, second computing device, and third computing device, according to various implementations of the invention.

FIG. 11 illustrates a process for adding a file to a computing device, according to various implementations of the invention.

FIGS. 12A, 12B, and 12C illustrate a block diagram of an exemplary reference directory of a home computing device, second computing device, and third computing device after the removal of the file, according to various implementations of the invention.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” or “containing” or “contains” when used herein, specify the presence of stated features, regions, integers, steps, operations, elements, and/or components, but do not preclude the presence or addition of one or more other features, regions, integers, steps, operations, elements, components, and/or groups thereof.

It will be understood that the term “and/or” includes any and all combinations of one or more of the associated listed items. It will also be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

However, for a comprehensive explanation of some terms used herein. The following descriptions are provided to clarify the logical relationship between some terms used herein. The term “file” used herein may include a collection of related data stored in a non-transitory computer readable storage medium. Said collection of related data is also described by the term “content” used herein. However, besides “content”, a file further includes data about “content” which is described by the term “metadata” of a file or “file information” used herein. The term “representative” used herein may include images, symbols, texts or combination of the aforementioned to represent a “file”, especially “content” of a “file”. However, it should be noted that the descriptions are only for the purpose to provide a comprehensive understanding between the terminologies “file”, “content”, “metadata” and “representative” used herein. The description should not be interpreted as or be limited to a formal definition or the only interpretation of the terminologies. It is emphasized herein that the meaning of the aforementioned terminologies should, as mentioned in the previous paragraph, have the same meaning as commonly understood by one of ordinary skill in the art to which this invention belongs and be interpreted as having a meaning that is consistent with their meaning in the context of the relevant art and the present disclosure.

A system and method may be provided for enabling access to a file in a computing system that includes multiple computing devices, wherein a file is accessed based on a reference file stored at a computing device that comprises a hash value of the content of the file. The hash value may be independent of the file location or file name and include a representation of the content of the file such that a given hash value is unique for given content. For example, the hash value may be generated using a hash function on the content of the file. The hash function may be generated by the hash function that reproducibly identifies the file based on the content of the file. As such, unlike conventional file links and representations, even if the location or name of the file or reference file changes, the reference file may continue to be used to obtain the file. In this manner, the reference file may be used to uniquely identify a file (within the limits of such hash or similar functions) as well as serve as a basis for checking the integrity of files transmitted over a network from one computing device to another computing device.

For each file stored locally at a computing device, that computing device may also store or otherwise generate the reference file that corresponds to the file and an association between the reference file and the locally stored file. A same hash function used to generate the hash value for each reference file stored in the system. The hash function may be pre-stored at each computing device of the system. In some implementations, the hash function may be changed based on user input at a given computing device. In response to a change of the hash function, the changed hash function may be propagated to each other computing device of the set of computing devices.

In some implementations, multiple hash functions may be used to generate the hash values of reference files. A set of rules may govern which hash function is used for a document. For example, a first rule may govern that files with a size in a first range of sizes may be associated with a first hash function, while files with a size within a second range of sizes may be associated with a second hash function. In another example, a second rule may govern that files with a document type of a first set of document types may be associated with a first hash function while files with a document type of a second set of document types may be associated with a second hash function. Associations between the various hash functions used in generating reference files and the rules associated with the use of those hash functions may be stored in the individual non-transitory storage devices of each computing device of the set of computing devices.

In some implementations, the reference file may be associated with a file name that is based on a file name of the file. For example, a given file name of a file may include an extension or other application identifier that indicates to an operating system an application used to open the file. A computing device that generates a reference file may add to the file name of the file an additional extension or other appendage that indicates that it is a reference file and use the appended file name to name the reference file. In some implementations, the reference file may include an encoding that indicates an application type that references an application to be used to open the file. In some examples, the reference file may encode multiple application types which may be used to open the file. The application type encoded in the reference file may be derived and/or otherwise based on the file name of the file. For example, the application type may be derived and/or otherwise based on the extension and/or other application identifier of the file name. In this manner, whichever application is associated with the file may be launched to open the file when the file is obtained based on the reference file. Thus, the reference files described herein may be used at the file system level to identify/represent different types of files opened by different types of applications.

The reference files described herein may be used in various contexts. For example, the reference file may be used in association with a content provider who provides a reference file that, when transmitted to the content provider, causes the content provider to identify corresponding content and provide the content to a requesting computing device. In this manner, a computing device may download one or more reference files corresponding to content (e.g., videos, pictures, etc.) at the content provider and then later use a given reference file to download corresponding content from the content provider. Accordingly, the computing device need not download the entire content from the content provider, but rather only a reference file that corresponds to the content, thereby preserving disk or other storage space on the computing device while maintaining a list of selectable reference files that each correspond to content that may be later obtained from the content provider based on a selected reference file. As such, even if the name or location (e.g., Uniform Resource Locator (“URL”)) of the content is changed at the content provider, the reference file may still be used to identify and obtain the content, eliminating instances of broken URL and other links.

In other examples, the reference file may be used in association with a set of computing devices that is associated with a user, a family, an organization, a company, and/or other entity. Each computing device in the set of computing devices may store different files. For example, one computing device may store one file while another computing device may store another file. Instead of storing each of the files in all of the computing devices, a given computing device may simply store a reference file that corresponds to a file that is stored at another computing device. In this manner, a given computing device may request a file stored at another computing device by transmitting a reference file to the other computing device.

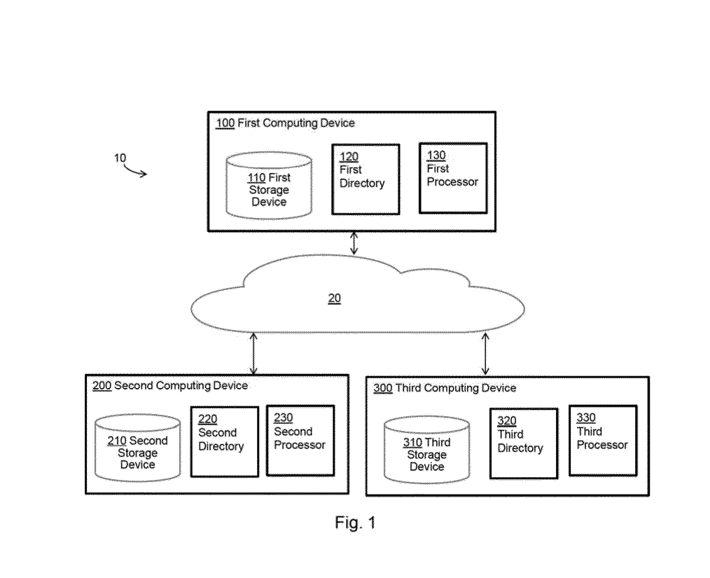

FIG. 1 illustrates an exemplary diagram of a system 10 for enabling access to a file in a computing system that includes a set of computing devices, the set of computing devices comprising, for example, a first computing device 100, a second computing device 200, a third computing device 300, and/or other computing devices, according to an implementation of the invention. The system 10 may include a network 20 via which the first computing device 100, the second computing device 200, the third computing device 300, and/or other computing devices of the system 10 may communicate.

The set of computing devices (e.g., the first computing device 100, the second computing device 200, the third computing device 300, and/or other computing devices of the system 10) of the system 10 may be associated with a user, a family, an organization, a company, and/or other entity. Each individual computing device of the set of computing devices may comprise a local non-transitory electronic storage device, a directory comprising a representation of the full set of files available across the set of devices, one or more physical processors programmed to execute computer readable instructions to cause the computing device to execute functionality, and/or other system components. A representation of a file may comprise a file stored locally on the individual device, a reference file relating to the file, and/or other information related to the file. For example, the first computing device 100 may comprise a non-transitory electronic storage device 110, a first directory 120, and a first processor 130, the second computing device 200 may comprise a second non-transitory electronic storage device 210, a second directory 220, and a second processor 230, and the third computing device 300 may comprise a third non-transitory electronic storage device 310, a third directory 320, and a third processor 330.

The first computing device 100 may store a first set of files (e.g., file F2) locally in the first non-transitory electronic storage device 110. The first set of files may be locally stored based upon a first storage policy associated with the first computing device 100. For each file stored at a non-transitory electronic storage device of a given computing device, that computing device may also store or otherwise generate the reference file that corresponds to the file. For example, the first non-transitory electronic storage device 110 may store the first set of files as well as a corresponding first set of reference files, such that each individual reference file corresponds to a particular one of the first set of files. The computing device may also store an association between the file and the corresponding reference file. In some implementations, the first non-transitory storage device 110 may also store the hash function used to generate the hash value of the content of one of the first set of files.

In one embodiment of the present invention, for files stored at the first, second and third non-transitory electronic storage devices 110, 210 and 310, each of the computing devices 100, 200 and 300 determines to either generate a reference file that corresponds to the file or store the file its the electronic storage device (e.g. 110, 210, 310). For example, the first electronic storage devices 110 each may store a first set of files and may store a second and a third sets of reference files corresponding to a second and a third sets of files stored in the second and third non-transitory electronic storage devices 210 or 310 respectively. Therefore, each of the first, second and third non-transitory electronic storage devices 110, 210 and 310 may store a set of files and a set of reference files corresponding to the files stored in the other non-transitory electronic storage devices. Moreover, each individual reference file stored in a non-transitory electronic storage device may correspond to one or more particular files stored the other non-transitory electronic storage device. However, in some implementations, each individual reference file stored in a non-transitory electronic storage device may also correspond to one or more particular files stored in the other non-transitory electronic storage device itself. The computing devices may also store an association between the file and the corresponding reference file for identifying the file with the corresponding reference file. In one embodiment of the present invention, the first non-transitory storage device 110 may also store the hash function used to generate the hash value of the content of one of the first set of files. In some implementations, the first non-transitory storage device 1010 may store the hash value of the content of one of the first set of files in one of the reference files corresponding to the aforementioned one of the first set of files. In addition, the hash value stored in said reference file may merely correspond to the content of said file regardless of the location of said file. That is, the hash value of said reference file may reproducibly identify said content regardless the location of said content or which file said content contained therein.

In one embodiment of the present invention, as mentioned above, a same hash function used to generate the hash value for each reference file stored in the system or multiple hash functions may be used in accordance with a set of rules associated with the multiple hash functions. The hash function(s) may be pre-stored at each computing device of the set of computing devices (e.g., at the first non-transitory storage device 110 of the first computing device 100, at the second non-transitory storage device 210 of the second computing device 200, and at the third non-transitory storage device 310 of the third computing device 300). Any change to the hash function(s) at a given computing device may be propagated to each other computing device of the set of computing devices.

As mentioned above, a set of files stored at a given computing device may be governed by a storage policy for that computing device. A storage policy for an individual computing device may comprise, for example, a set of rules relating to the types of files that may be stored locally at the individual computing device. For example, the set of rules may comprise a first rule that files greater than a predetermined size may not be stored locally, a second rule that a predetermined amount of storage must be kept free at the local storage of the individual computing device, a third rule that only files accessed within a predetermined time period may be stored locally, and/or other rules related to the types of files that may be stored locally at the individual computing device. The second storage policy for the second computing device 200 may comprise a second set of rules different from the third set of rules of the third storage policy of the third computing device 300. In some implementations, a reference file corresponding to each of files stored locally at an individual computing device may be generated and stored in other computing devices. As a result, by using reference files stored in individual computing device to request corresponding files from the other computing devices, each of the individual computing device may keep remote access of all files stored in of the computing devices without storing all the files therein.

In another embodiment of the present invention, each computing device among the set of computing devices may be associated with its own storage policy. For example, the first computing device 100 may be associated with a first storage policy while the second computing device 200 may be associated with a second storage policy while still the third computing device 300 may be associated with a third storage policy, and so on. As such, the first computing device 100 may store a first set of files and/or reference files that are different than the second set of files and/or references files stored at the second computing device.

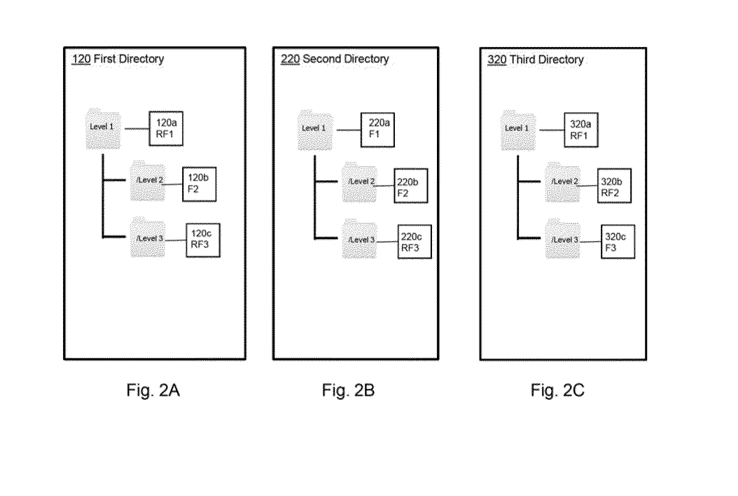

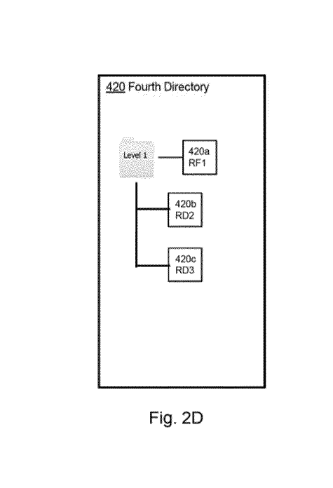

Each individual computing device in the set of computing devices (e.g., the first computing device 100, the second computing device 200, the third computing device 300, and/or other computing devices) may manage an individual reference directory (e.g., first reference directory 120, second reference directory 220, third reference directory 320, and/or other reference directories, respectively). FIGS. 2A, 2B, and 2C illustrate block diagrams of exemplary reference directories 120, 220, 320 of the first computing device 100, the second computing device 200, and the third computing device 300, according to various implementations of the invention. An individual reference directory of an individual computing device may comprise a representation of the files that are available across the set of devices. The representation of a file may comprise an indication of a file stored locally on the individual device, an indication of a reference file corresponding to the file, and/or other information related to the file. In one embodiment of the present invention, the aforementioned reference directory may correspond to a file system of each computing devices. Said representation may comprise a file name, file metadata and an icon corresponding to thumbnails or file type of files and reference files in said file system. The file metadata may comprise thumbnail of the (reference) file, a last updated time/date stored in the (reference) file, and/or other information in the (reference) file. In one embodiment of the present invention, the representation may further comprise a file extension representing file type of the files and the reference files. Further, the reference files may have a specific file type and corresponding file extension for the reference directory to distinguish from the files and to launch a corresponding computer program for processing reference files. For example, the representation of the reference files in the file system may have “˜” as its file extension corresponding to reference file opener or “.˜opener” for operating system of each the computing device to launch the opener according to the “˜” file extension. The operating system may launch the reference file opener as long as a selected file is a reference file. In other words, the operating system may launch a “.˜opener” as long as a file with “˜” as its file extension is selected. Moreover, a file type identifier for the operating system to launch for processing content of the file may be also included in the file name in a file extension format. For example, a reference file corresponding to a JPEG format image may include “.jpg” in its file name. The operating system of the computing device may launch a default JPEG file opener to process the image according to the “.jpg” in the file name of the said reference file. More specifically, the file type identifier may be positioned in front of the file extension of the reference file such as “.jpg.˜”. In some implementations of the present invention, the rules of the storage policy may correspond to metadata of the files, such as file size, file type or format, last updated time/date stored in the file . . . etc. The computing device may determine whether to store the content locally based on the comparison between at least one of the aforementioned metadata to at least one of rules of the storage policy. For example, the computing device may determine not to locally store video corresponding to a reference file according to a corresponding rule of the storage policy. Instead, the computing device may launch a video player for received streaming video data corresponding to the reference file but not to locally store a file of the received video in its non-transitory storage device.

In some implementations, a given computing device may store either the actual file or a reference file for the actual file for all of the files stored by the set of devices and accessible by the system. For example, first computing device 100 that locally stores the first set of files may store at least some of the files of the second set of files locally stored by the second computing device 200 and store any ones of the second set of files that are not stored at the first computing device as corresponding reference files. The second computing device 200 may similarly store at least some of the first set of files and store other ones of the first set of files as corresponding reference files.

The first computing device 100 may maintain and display in the first reference directory 120 a listing of the first set of files, a listing of the second set of files that were downloaded, and a listing of reference files corresponding to any of the second set of files that were not downloaded. The second computing device 200 may likewise maintain and display its own reference directory 220.

As shown in FIGS. 2A, 2B, and 2C, an individual reference directory may comprise a set of folders in which users of the computing devices may store, move, delete, and/or otherwise manage files. Each individual reference directory of each respective computing device may comprise an identical structure of the set of folders. In some implementations, the reference directory may be capable of managing nested folders in which files may be stored. Each reference directory may be synced with each other reference directory, such that any individual reference directory of a computing device of the set of computing devices may comprise an accurate depiction of the files available across the set of computing devices.

A reference directory may be synced with another reference directory with respect to structure of the reference directory (e.g., the folder structure, folder names, and metadata associated with the folders and/or the reference directory as a whole, and/or other information related to the structure of the reference directory) as well as content in the reference directory (e.g., the file representations of the files available across the set of devices, placement of a file in a particular metadata, metadata associated with a file, metadata associated with a computing device, metadata associated with the set of computing devices, and/or other information related to the content of the reference directory). Accordingly, in some implementations, a given computing device may update its reference directory based on updates received from the home computing device and/or other computing devices of the set of computing devices. For example, a first computing device and a second computing device may store an actual file in a particular location of their corresponding reference directories (e.g., at a particular folder or other location within their reference directories). A third computing device may store a reference file corresponding to the actual file in the same particular location of its reference directory.

If the actual file from the second computing device is moved to a particular location within the reference directory, the second computing device may cause the first computing device and the third computing device to be notified of the update as described herein. In response, the first computing device may change the location of its actual file to the particular location in its reference directory (creating the particular location/folder as necessary). Likewise, the third computing device may change the location of its reference file to the particular location in its reference directory. Other updates such as a file name change, addition of a file, deletion of a file, etc., may be likewise synchronized across each reference directory, providing a uniform user experience across all devices among the set of devices with respect to files that are available locally and/or remotely.

As shown in FIGS. 2A, 2B, and 2C, the first directory 120 of the first computing device 100 may comprise a representation of the files available across the computing devices of the system (e.g., files F1, F2, and F3). For example, at level 1 of each of the directories, a file representation of file F1 may be stored. At level 2 of the directories, a second file representation related to file F2 may be stored. At level 3 of the directories, a third file representation related to file F3 may be stored.

In some examples, the first computing device may store files F2 in the first non-transitory electronic storage device 110, the second computing device may store files F1 and F2 in the second non-transitory electronic storage device 210, and the third computing device may store file F3 in the third non-transitory electronic storage device. In these examples, the first file representation 120a of file F1 in the first directory 120 may store a first reference file RF1 related to file F1, the first file representation 220a of file F1 in the second directory 220 may store the file F1, and the first file representation 320a of file F1 in the third directory 320 may store the first reference file RF1 related to file F1. The second file representation 120b of file F2 in the first directory 120 may store the file F2, the second file representation 220b of file F2 in the second directory 220 may store the file F2, and the second file representation 320b of file F2 in the third directory 320 may store the second reference file RF2 related to file F2. The third file representation 120c of file F3 in the first directory 120 may store a third reference file RF3 related to file F3, the third file representation 220c of file F3 in the second directory 220 may store the third reference file RF3 related to file F3, and the third file representation 320c of file F3 in the third directory 320 may store the file F3.

As shown in FIG. 2D, in one embodiment of the present invention, a fourth computing device may maintain and display a fourth directory 420. The fourth computing device may not even store a folder locally such as the “level 2”, “level 3”. Instead, the fourth computing device may create a reference file RD 2 corresponding to the “level 2” folder containing the file F2. More specifically, in some implementations, the fourth computing device may generate a content identification (content ID) from the file F2 and the “level 2” folder and create the reference file RD2 including the content identification. In some implementations, the content ID may be generated from the content of the file F2 and the folder name of the “level 2” folder by a hash function. In some other implementations, a first hash value may be generated from the content of the file F2 by a hash function, and the content ID may be a second hash value generated from the first hash value and said folder name. In one embodiment of the present invention, a storage policy including rules for expanding folders of the directory 420 may be stored in the fourth computing device. The fourth computing device may determine whether to locally store files in a folder or a folder itself according to the rules of the storage policy. Responsive to a determination not to store the folder locally, the fourth computing device may create a reference file corresponding to the folder and store the reference file instead.

In some examples, a file stored in the directory as a file representation (e.g., file F2 stored in the level folder of the second directory 220) may be stored in its entirety, may be split into file chunks that are separately stored, and/or may otherwise be stored. In some implementations in which a file is split into file chunks, the file may be split into a set of file chunks of predetermined size. Each file stored as a file representation in an individual directory may be split into file chunks of the predetermined size. In some implementations, a file stored in a non-transitory electronic storage device may be stored as a set of file chunks of predetermined size. In some implementations, the predetermined size may be 2 MB, 4 MB, 8 MB, and/or another size. In some implementations, the predetermined size may be set by an administrator of the system, may be pre-set with the use of the directory, may be revised by an administrator and/or other user of the system, and/or may otherwise be determined. In some implementations, the predetermined size may be determined based on the set of rules available for a storage policy for an individual computing device.

In some examples, a file stored in the directory as a file representation (e.g., file F2 stored in the level folder of the second directory 220) may be stored as a comparison to another file. In some implementations, a modified file may be stored as a comparison to an earlier version of the file. Each newly created file may be stored entirely or split into file chunks, and each modified file may be stored as comparison to the previous version (before modification) of the file. In some implementations, a modified file stored in a non-transitory electronic storage device may be stored as a comparison to the previous version of the file.

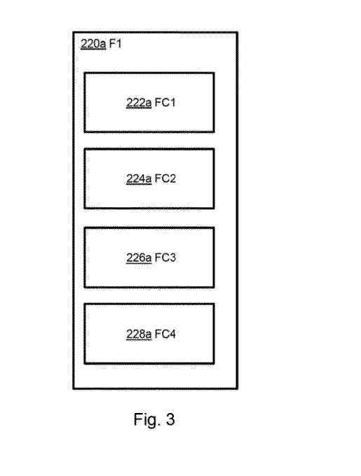

FIG. 3 illustrates a block diagram of an exemplary file stored in a non-transitory storage device of a computing device or as a file representation in a reference directory of the computing device, according to various implementations of the invention. In particular, FIG. 3 illustrates file F1 stored in the level 1 folder of the second directory 220. File F1 may comprise a first file chunk FC1 of the predetermined size, a second file chunk FC2 of the predetermined size, a third file chunk FC3 of the predetermined size, and a fourth file chunk FC4 of the predetermined size. In another example, as discussed above, file F1 may be stored in its entirety, and the file chunks FC1, FC2, FC3, and FC4 may be generated in response to an access of the file F2.

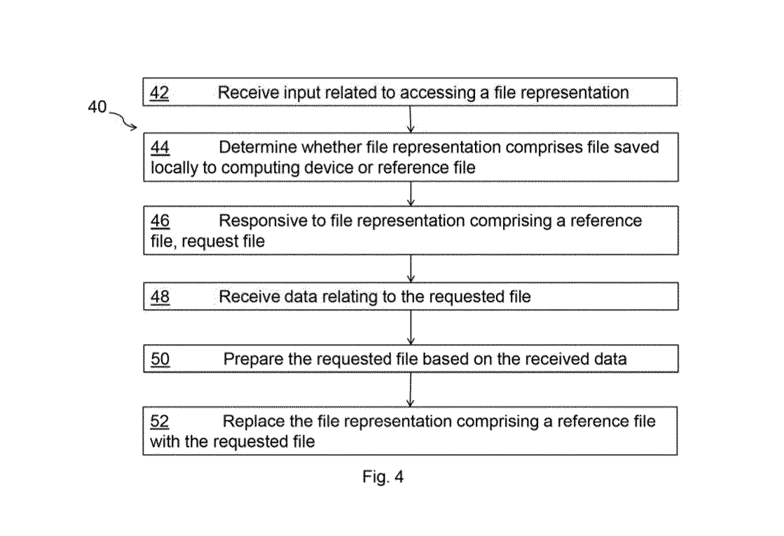

FIG. 4 illustrates an exemplary process of accessing a file via a reference directory of a given computing device, according to various implementations of the invention.

In an operation 42, a computing device may receive input related to accessing a file. For example, each computing device may display its reference directory (and the corresponding set of file representations) via a display of the respective computing device. In some implementations, a reference file may comprise a hash value of content of the corresponding file. In some implementations, the reference file may also comprise, for example, a file name of the corresponding file, a thumbnail of the content of the corresponding file, an indication of an application via which the corresponding file may be accessed, an association with an access file, a time of last update of the corresponding file, a time of creation of the corresponding file, and/or other information related to the file. Some or all of the information of the reference file may be displayed with the reference directory. A computing device (e.g., the second computing device 200) may receive an indication from a user related to accessing a file. For example, the indication may comprise user interaction with the displayed file representation.

In an operation 44, the second computing device 200 may determine whether the file representation represents a file stored locally at the second non-transitory storage device 210 or whether the file representation represents a reference file for the requested file. Responsive to the file representation representing a file stored locally at the second non-transitory storage device 210, the second computing device 200 may make the file available to the user. For example, the second computing device 200 may output the file to the user, query the user whether the user would like to open the file via one of a plurality of available applications on the second computing device 200, display the file via an application based on the file name of the file, and/or otherwise make the file available to the user.

In an operation 46, responsive to the file representation representing a reference file, the second computing device 200 may request the file. The second computing device 200 may send a request for the file to each other computing device in the set of computing devices, to a predetermined number of computing devices with a shortest proximity to the second computing device 200, a predetermined number of computing devices with a fastest connection speed to the second computing device, a home computing device (discussed further below), computing devices included in a list of computing devices stored in the second non-transitory storage device 210, any combination thereof, and/or other computing devices in the set of computing devices.

Responsive to another computing device receiving the request, the other device may check to determine whether its non-transitory storage device stores the requested file. For example, the other computing device may compare the reference file received from the second computing device with its pre-stored version of the reference file, which may be associated with the file. The other computing device may identify the file based on the comparison (e.g., a match between the received reference file and its pre-stored version of the reference file) and provide the file (or portions of the file) to the second computing device. Because the reference file is generated based on the content of the file, even if the name or location of the file changes, the reference file may still be used to identify and obtain the file. Likewise, even if the name or location of the reference file changes, the reference file may be used to identify and obtain the file. In one embodiment of the present invention, the reference file may contain a content identification (content ID) generated based on the content of the file. Meanwhile, the other computing device may maintain a database keeping records including said content ID and/or other information of the file. The other computing device may retrieve the content ID from the received reference file to identify the file. In some implementations, the second computing device 200 may retrieve the content ID from the reference file and send the content ID to the other computing for requesting the file. In some implementations, the aforementioned content ID may be generated from the content of the file by a hash function. Responsive to the other computing device storing the requested file, the other computing device may send a notification to the second computing device 200 that it stores the requested file. In some implementations, responsive to the other computing device not storing the requested file, the other computing device may send a notification to the second computing device 200 that it does not store the requested file locally. In some implementations, responsive to the other computing device not storing the requested file, the other computing device may not send any response to the second computing device 200.

The second computing device 200 may receive a notification from one or more of the computing devices to which it sent the request. The second computing device 200 may request the file from one of the computing devices from which it receives an indication that the file is available. In some implementations, the second computing device 200 may request the file from a computing device that sent the first notification received by the computing device 200. In some implementations, the second computing device may select a computing device from the group of computing devices associated with notifications received during a predetermined time period after sending the request. For example, the second computing device 200 may select the computing device within the closest proximity to the second computing device 200, the computing device with the fastest connection speed to the second computing device 200, and/or a computing device with one or more other desirable characteristics. Responsive to selecting a computing device from which to receive the file, the second computing device 200 may send a request to the selected computing device (e.g., the first computing device 100) to receive the file.

In an operation 48, the second computing device 200 may receive data related to the requested file. In some implementations, responsive to receiving the request to receive the file, the first computing device 100 may send the file in its entirety to the second computing device 200. In some implementations, the first computing device 100 may send individual file chunks of the file to the second computing device 200. The file may be stored as the individual file chunks at the first non-transitory storage device 100, the file chunks may be generated responsive to receiving the request for the file, and/or the file chunks may otherwise be made available for sending. In some implementations, the first computing device 100 may send reference files for each individual file chunk before sending the file chunks to the second computing device 200.

The first computing device may generate a reference file for the file chunk using the same hash function used to generate the reference file for the requested file.

The second computing device 200 may receive information relating to the file chunk. The information relating to the file chunk may comprise an individual reference file for the file chunk, where the individual reference file includes a hash value of the content of the file chunk, an order of the file chunk relative to the other file chunks that constitute the requested file, and/or other information related to the file chunk. The second computing device 200 may determine whether the second non-transitory storage device 210 stores the file chunk. Responsive to a determination that the second non-transitory storage device 210 does not store the file chunk, the second computing device 200 may request the file chunk from another computing device. In some implementations, the second computing device 200 may request the file chunk from the one or more computing devices to which it sent the request for the file, from a home computing device (as discussed below), and/or other computing devices in the set of computing devices. The second computing device 200 may receive the requested file chunk and store the requested file chunk in the second non-transitory storage device 220, a cache of the second computing device 200, and/or other storage of the second computing device 200.

In an operation 50, the second computing device 200 may prepare the requested file based on the received data. Responsive to the second computing device 200 storing all of the file chunks of the requested file, the second computing device 200 may aggregate the file chunks of the file in the order provided by the first computing device 100 as the requested file. The second computing device 200 may save the requested file in the second non-transitory storage device 220. Moreover, in one embodiment of the present invention, the aforementioned file may be stored, sent and received as a comparison to another file such as a diff format file corresponding to an earlier version of the file instead of said file chunks.

In an operation 52, the second computing device 200 may replace the file representation with the reference file in the second reference directory 220 with a file representation for the actual requested file. In some implementations, the second computing device 200 may replace the reference file with the actual file in the second non-transitory storage device 200. Moreover, in one embodiment of the present invention, the second computing device 200 may further store a storage policy defining rules for locally storing content in the second non-transitory storage device 210. By checking the rules of the storage policy, the second computing device 200 may determine whether to locally store the content in the second non-transitory storage device 210. Responsive to a determination to locally store the content, the second computing device 200 may store the actual file in the second non-transitory storage device 210. In some implementations, the second computing device 200 may further launch a computer program for processing the content. Responsive to a determination that the content should not be locally stored, the second computing device 200 may launch the computer program for processing the content only but store the content in a transitory storage such as memory of the second computing device 210 instead of the second non-transitory storage device 210. The selective reference file corresponding to the content of the actual file may be still stored in the second non-transitory storage device 210 after retrieving and processing the content. However, in another embodiment of the present invention, response to locally store the content, the second computing device 200 may further determine whether to change another actual file (e.g. a second file) to another reference file (e.g. a second reference file) based on the storage policy. Responsive to a determination to change the second file to the second reference file, the second computing device 200 may generate the second reference file from the content of the second file and replace the second file with the second reference file. In some implementations, for ensuring the content of the second file is accessible, the second computing device may send another request to verify that a file containing the content of the second file is stored in the set of the computing devices to each other computing device in the set of computing devices, to a predetermined number of computing devices with a shortest proximity to the second computing device 200, a predetermined number of computing devices with a fastest connection speed to the second computing device, a home computing device (discussed further below), computing devices included in a list of computing devices stored in the second non-transitory storage device 210, any combination thereof, and/or other computing devices in the set of computing devices. The second computing device 200 may replace the second file with the second reference file only if the second computing device 200 receives a notification from at least one of the set of computing devices. In some embodiment of the present invention, if the second computing device 200 does not receive any notification from the set of computing devices, the second computing device 200 may send the second file to the home computing device (discussed further below) for backing up the content of the second file and replace the second file with the second reference file. In one embodiment of the present invention, the rules of the storage policy may correspond to file information of the second file such as file type, file size, time of file creation . . . etc.

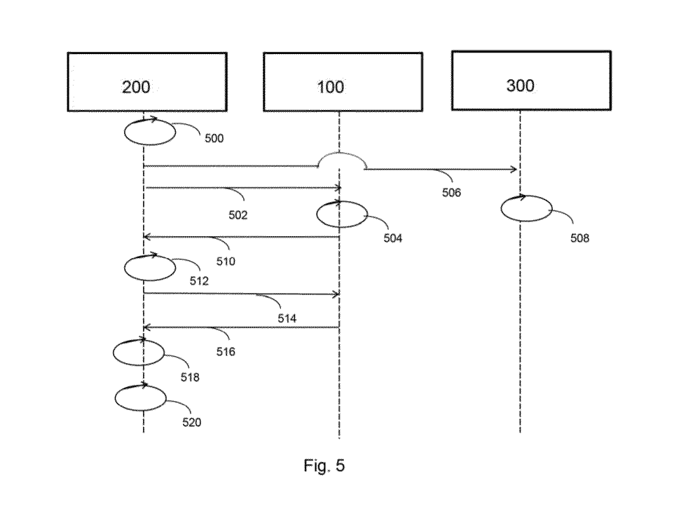

FIG. 5 illustrates a data flow diagram of accessing a file in the computing system, according to various implementations of the invention. In some implementations, the data flow diagram illustrates a particular example of accessing a file according to the process displayed in FIG. 4.

In an operation 500, the second computing device 200 may receive a request to access a file, in a manner similar to that described with regard to FIG. 4. In operations 502 and 506, the second computing device 200 may send the reference file corresponding to the requested file to the first computing device 100 and the third computing device 300. In an operation 504, the first computing device 100 may determine whether the first computing device 100 stores the requested file based on the received reference file, in a manner similar to that described with regard to FIG. 4. In an operation 508, the third computing device 600 may determine whether the first computing device 100 stores the requested file based on the received reference file, in a manner similar to that described with regard to FIG. 4. Responsive to determining that the third computing device 300 does not store the requested file, the third computing device 300 may not respond to the request for the file.

In some implementations, responsive to the first computing device 100 determining that it stores the requested file, the first computing device 100 may send an indication of such to the second computing device, and may wait to send data of the requested file in an operation 510 until receiving the request to receive the file from the second computing device 200. In some implementations, in an operation 510, responsive to the first computing device 100 determining that it stores the requested file, the first computing device 100 may send data of the requested file. The data sent by the first computing device may comprise information relating to a file chunk of the requested file. The information relating to the file chunk may comprise an individual reference file for the file chunk, where the individual reference file includes a hash value of the content of the file chunk, an order of the file chunk relative to the other file chunks that constitute the requested file, and/or other information related to the file chunk. In an operation 512, the second computing device 200 may determine whether the second non-transitory storage device 210 stores the file chunk. In an operation 514, responsive to a determination that the second non-transitory storage device 210 does not store the file chunk, the second computing device 200 may request the file chunk from the first computing device 100. In an operation 516, the second computing device 200 may receive the requested file chunk and store the requested file chunk in the second non-transitory storage device 220, a cache of the second computing device 200, and/or other storage of the second computing device 200. Moreover, in one embodiment of the present invention, the aforementioned file may be stored, sent and received as a comparison to another file such as a diff format file corresponding to an earlier version of the file instead of said file chunks.

In an operation 518, the second computing device 200 may prepare the requested file based on the received data and save the requested file in the second non-transitory storage device 210, in a manner similar to that described with regard to FIG. 4. In an operation 520, the second computing device 200 may replace the file representation with the reference file in the second reference directory 220 with a file representation for the actual requested file, in a manner similar to that described with regard to FIG. 4.

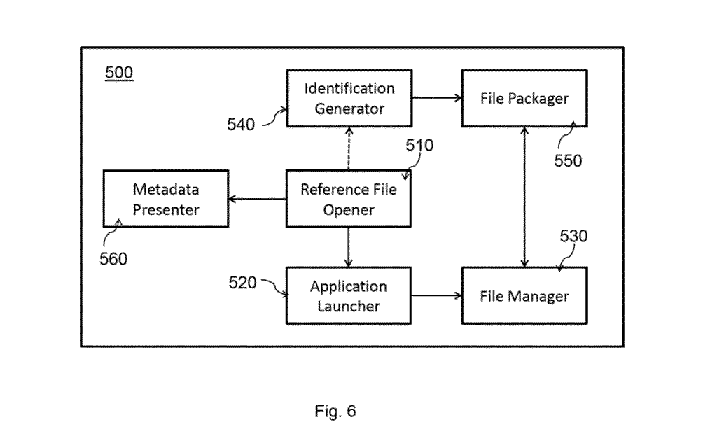

FIG. 6 illustrates a block diagram of a system for creating aforementioned reference file and accessing corresponding contents in the computing system, according to various implementations of the invention. In some implementations, the system illustrated in FIG. 6 may be implemented in the computing devices 100, 200 and 300 depicted in FIG. 1.

Referring to FIG. 6, the system 500 may comprise a reference file opener 510 for an operating system of a computing device (e.g. the first computing device 100) to launch to process a reference file stored in the first non-transitory storage device 110 if the reference file is selected. The reference file opener 510 may retrieve an association between the reference file and corresponding content from the reference file. In one embodiment of the present invention, said association may be a content ID generated from said content by a first algorithm. More specifically, the first algorithm may be a hash function for generating a string of fixed size from the content. The reference file opener 510 may further request content by the aforementioned association (e.g. a hash value as content ID of the content). Particularly, the reference file opener 510 may send a request including the hash value to the set of computing devices depicted in FIG. 1. Each of the set of computing devices receiving the request (e.g. the second computing device 200) may determine whether a file containing the content is stored therein and identify the file by the content ID responsive to a determination that the file is stored in the second non-transitory storage device 210 (or more specifically, the second directory 220). In some implementations, the second computing device 200 may maintain a database for keeping records of hash values generated from contents of files stored in the second non-transitory storage device 210 and/or the second directory 220. The second computing device 210 may identify the requested content by comparing the content ID to the hash values in the database. The second computing device 200 may further transmit the content to the first computing device 100 after identifying the requested content.

The system 500 may further include an application launcher 520 for identifying a computer program to be launched for processing the content after the first computing device 100 receiving the content. In one embodiment of the present invention, the application launcher 520 may identify said computer program by retrieving a file type identifier from the reference file. In some implementations, the application launcher 520 identifies the computer program by analyzing the file name of the reference file and retrieving the file type identifier (e.g. file name extension) corresponding to the computer program from the file name. The application launcher 520 may further launch the computer program to process the content or notify the operating system of the first computing device 100 to process the content.

Further, the system 500 may comprise a file manager 530 for determine whether to locally store the content in the non-transitory storage device 110 (more specifically, the representation directory 110). Responsive to a determination to locally store the content, the file manager 530 may create a file containing the content and store the file. In one embodiment of the present invention, the file manager 540 may maintain a storage policy including rules for said determination. Said rules may correspond to metadata of the file containing the content which may also be included in the reference file. For example, said metadata may include file type, file size, time of file creation . . . etc. In one embodiment of the present invention, the file manager 530 may further determine whether to transform another file (e.g. a second file) into reference file (e.g. a second reference file) for reserving storage responsive to a determination to locally storing the content. In some implementations, the file manager 530 may further send a request to the computing devices depicted in FIG. 1 for checking whether a file containing the content of the second file is stored in at least one of the computing devices. In one embodiment of the present invention, the system 500 may further comprise an identification generator 540 and a file packager 550 for transforming the second file into the second reference file. The identification generator 540 may generate a content ID from the content of the second file. In some implementations, the identification may include a hash function for generating a hash value from the content as the content ID. The file packager 550 may further create the second reference file including the content ID. The file manager 530 may further replace the second file with the second reference file. In some implementations, the file packager 550 may store a reference file identifier as a portion of the second reference file for the operating system of the first computing device 100 to launch the reference file opener 510 if the second reference file is selected. More particularly, the file packager may 550 may create the second reference file with a file extension in the file name corresponding to the reference file opener 510. For example, the file packager 550 may create the second reference file with a file name “image.jpg.˜” corresponding to the second file with a file name “image.jpg”, and wherein the “.˜” is the aforementioned file extension. Moreover, the file packager 550 may further store other metadata or information related to the second file as a portion to the second reference file such as content preview information (e.g. thumbnail) of the second file.

In addition, the system 500 may further comprise a metadata presenter 560 for retrieving metadata to be displayed by the first computing device 100. The metadata presenter 560 may be launched by the operating system of the first computing device 100 when one or more reference files are being displayed by the first computing device 100. In some implementations, the metadata presenter 560 may be launched along with the reference file opener 510 to retrieve more metadata when a specific reference file is selected. Said metadata may be contained in said reference files and may include file name, file type, date of file creation/update, thumbnail (content preview) . . . etc.

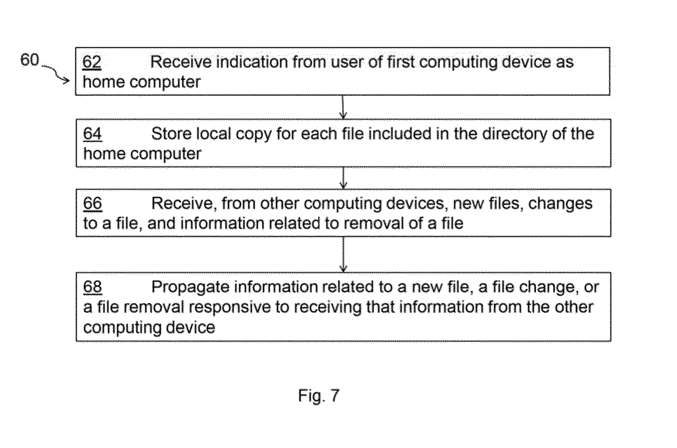

FIG. 7 illustrates a process for designating a computing device as a home computing device, according to various implementations of the invention. The set of computing devices may include one or more computing devices designated as a home computing device. The home computing device designation may be configured by the user of the set of devices such that the user may identify the one or more devices that are to serve as a home computing device. The home computing device may be programmed to locally store (e.g., in an internal or external storage that is accessible to the home computing device) a set of the files that is available across the set of devices. For example, the home computing device may store a first file from a first computing device and a second file from a second computing device, where the first file is not stored on the second computing device and the second file is not stored on the first computing device. In some implementations, the home computing device may be programmed to store all of the files that are stored at all of the remote computing devices such that each file stored at any given device among the set of devices is stored locally at the home computing device. If the home computing device cannot store a given file (e.g., because the size of the file exceeds the storage capacity of the home computing device, is not network accessible, etc.), then the given file may be stored at a third party storage device, such as a cloud storage device. Such cloud storage may be temporary until the home computing device is able to store the file.

In an operation 62, a computing device may receive an indication from a user of the computing device that designates that computing device as the home computing device. For example, the first computing device 100 may receive an indication from a user of the first computing device 100 that designates it as the home computing device 100. The home computing device 100 may also send a notification to each of the other computing devices in the set of computing devices indicating that the first computing device 100 has been designated as the home computing device 100.

In an operation 64, a local copy of each file stored across the set of computing devices may be stored in the first non-transitory storage device 110 of the home computing device 100. For example, the home computing device 100 may determine which files displayed in the reference directory are stored locally in the first non-transitory storage device 110. For each file not stored locally, the home computing device 100 may request the file from the set of computing devices in a manner similar to accessing the file as discussed above.

In an operation 66, the home computing device may receive, from each other computing device in the set of computing devices, any new files, changes a file, information relating to a removal of a file, and/or any other changes to data stored across the set of computing devices. The home computing device 100 may receive this information responsive to sending a notification to the other computing devices regarding the designation of the computing device as a home computing device 100.

In an operation 68, the home computing device 100 may be configured to propagate a change in data in another computing device to the other computing devices of the set of computing devices, responsive to receiving information regarding the change. For example, responsive to receiving a new file from the second computing device 200, the home computing device 100 may send information regarding the new file to each of the other computing devices in the set of computing devices. The information may comprise the new file and a new reference file corresponding to the new file. Depending upon a storage policy of a receiving computing device, the receiving device may either store the new file locally or store the reference file, and may update its reference directory correspondingly. The home computing device 100 may also save the new file in the first non-transitory storage device 110, generate/receive a new reference file corresponding to the new file, save the new reference file in the first non-transitory device 110, save an association between the new file and the new reference file in the first non-transitory storage device 110. The home computing device 100 may also update its reference directory correspondingly.

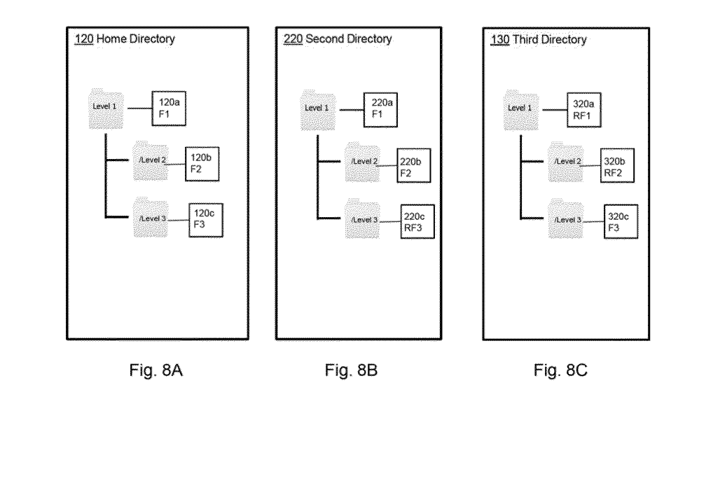

FIGS. 8A, 8B, and 8C illustrate a block diagram of an exemplary reference directory of a home computing device, second computing device, and third computing device, according to various implementations of the invention. For example, FIGS. 8A, 8B, and 8C illustrate the reference directories 120, 220, and 320 after the designation of the first computing device 100 as a home computing device 100. As shown in FIG. 8A, the reference directory 120 of the home computing device 100, each file representation of the reference directory comprises a corresponding actual file stored locally in the first non-transitory storage device 110.

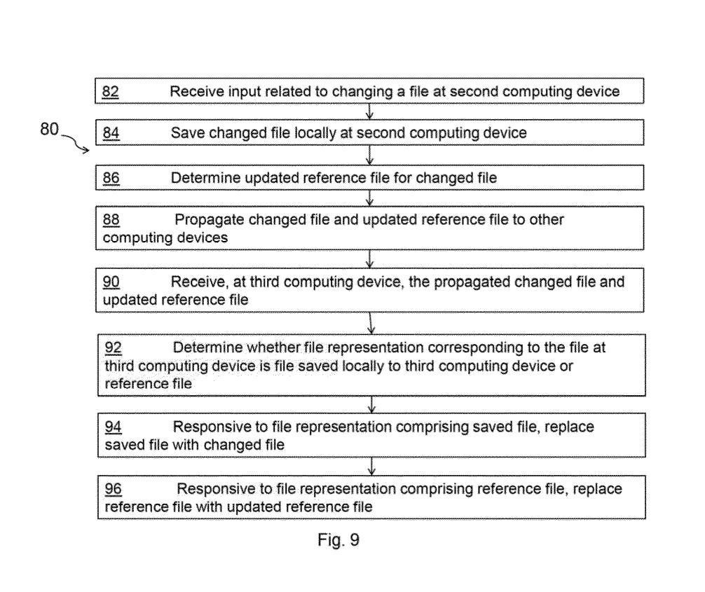

FIG. 9 illustrates a process for changing a file at a computing device and syncing directories across the set of computing devices, according to various implementations of the invention. Each of the devices may be programmed to communicate an update to a file stored thereon to one or more of the other computing devices in the set of computing devices. The update may include an indication of a new file, a change to an existing file, a removal (e.g., deletion) of a file, and/or other changes to stored information. For example, a given device may be programmed to identify a new file or reference file, changes to an existing file or reference file, a deleted file or reference file, file name changes, file location changes, and/or other changes related to files and reference files stored locally thereon. The given device may be programmed to communicate the update to the other devices in the set of devices. In some implementation, the given device may communicate the update to the home computing device, which propagates the update to the other devices. The home computing device may then make appropriate changes to its local copy of the file, and then cause similar updates to occur on the other computing devices. In some implementations, the given device may communicate the update to the other devices in a peer-to-peer, daisy-chain, and/or other configuration without using the home computing device as a coordinator of such updates.

In an operation 82, a computing device may receive input related to changing a file stored locally at the computing device. For example, a second computing device 200 may receive input relating to change a first file stored locally in a second non-transitory storage device 210 of the second computing device 200.

In an operation 84, the file may be changed via interaction with the second computing device 200 and the changed file may be saved locally at the second non-transitory storage device 210.

In an operation 86, the reference file corresponding to the file may be updated responsive to the change to the file. For example, a reference file corresponding to the file may be determined based on stored associations between files and reference files in the second computing device 200. The second computing device 200 may generate a new hash value based on the changed content of the first file and may update the reference file corresponding to the file. For example, the second computing device 200 may replace the existing hash value with the newly generated hash value. In some implementations, the second computing device 200 may also update a thumbnail of the corresponding reference file, a last updated time/date stored in the reference file, and/or update other information in the reference file responsive to the changed file. In some implementations, the second computing device 200 may store the original file, the original reference file, and/or other information relating to the file in the second non-transitory storage device. For example, the second computing device 200 may maintain storage of this information for version control.

In an operation 88, the second computing device 200 may propagate information relating to the changed file to the other computing devices of the set of computing devices. The information may comprise, for example, the original reference file (e.g., the reference file before it was updated), the changed file, the updated corresponding reference, file, and/or other information related to the changed file. In some implementations, the second computing device 200 may send the information to the home computing device 100, which may then propagate the information to other computing devices. In some implementations, the second computing device may send the information to each of the other computing devices in the set of computing devices.

In an operation 90, a third computing device 300 may receive the information related to the changed file. The third computing device may receive the information from the second computing device 200, the home computing device 100, and/or another computing device of the set of computing devices.

In an operation 92, the third computing device may determine whether a file corresponding to the changed file is stored locally at the third computing device 300. For example, the third computing device may determine whether the corresponding file is stored in the third non-transitory storage device 310, may determine whether a file representation in the reference directory stores a reference file for the corresponding file or the corresponding file itself, may determine whether the third non-transitory storage device 300 stores an association between the original reference file and a file stored locally at the third non-transitory storage device 300, and/or may otherwise determine whether the file is stored locally at the third computing device 300.

In an operation 94, responsive to the file being stored locally at the third computing device 300, the third computing device 300 may update the file representation corresponding to the file to comprise the changed file.

In an operation 96, responsive to the file not being stored locally at the third computing device 300, the third computing device 300 may replace the reference file with the updated reference file.

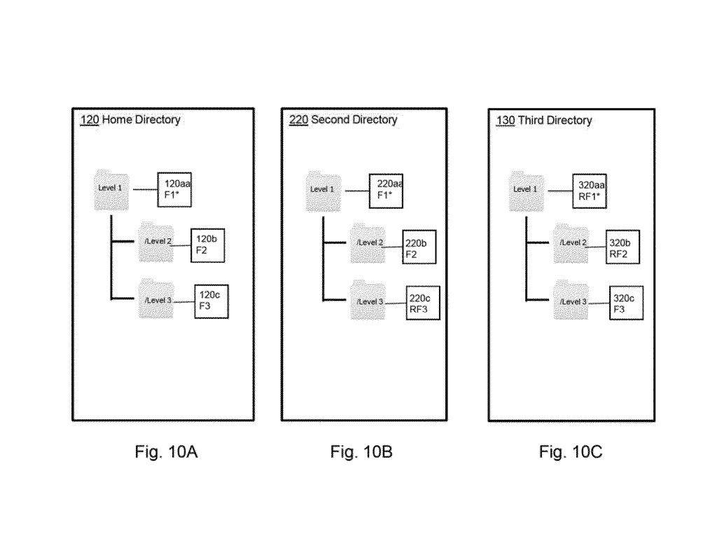

FIGS. 10A, 10B, and 10C illustrate a block diagram of an exemplary reference directory of a home computing device, second computing device, and third computing device, according to various implementations of the invention. For example, FIGS. 10A, 10B, and 10C illustrate the reference directories 120, 220, and 320 after the changes to the file F1 (i.e. changed file F1*) are propagated to each of the other computing devices in the set of computing devices.

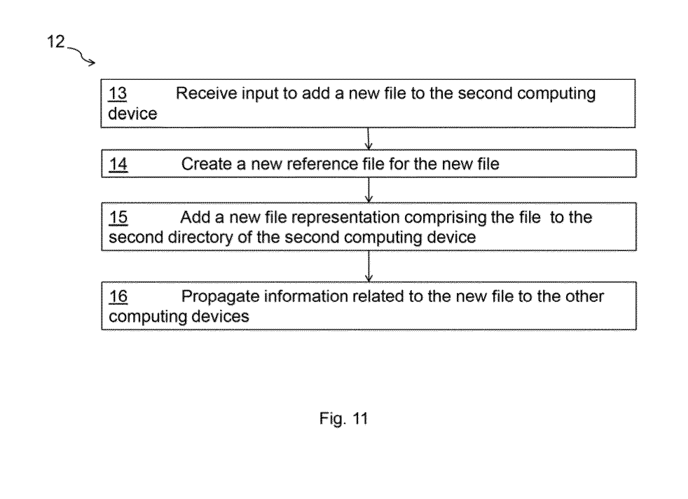

FIG. 11 illustrates a process for adding a file to a computing device, according to various implementations of the invention.

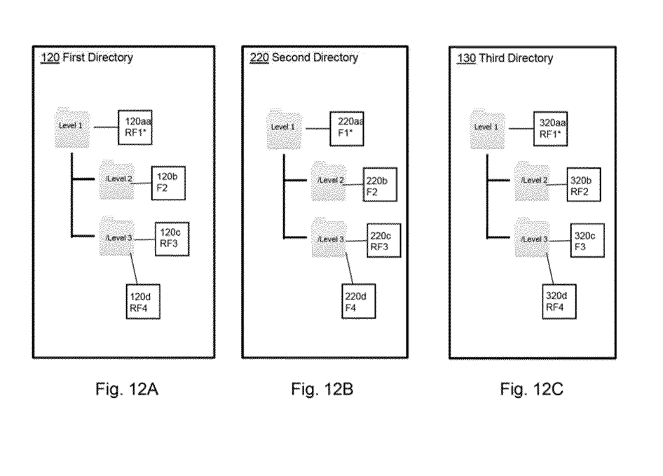

FIGS. 12A, 12B, and 12C illustrate a block diagram of an exemplary reference directory of a home computing device, second computing device, and third computing device after the removal of the file, according to various implementations of the invention. In some implementations, a given computing device may determine whether to request from another computing device content related to the update. For example, if a new file is created at another computing device, the given computing device may receive a reference file corresponding to the new file. The reference file may be received from the home computing device 100, the computing device that generated the new file, and/or other computing device in the set of computing devices. The given computing device may determine whether to download the new file by transmitting a request that includes the reference file to one or more computing devices in the set or simply store the reference file only (which may be used to later obtain the new file on demand).

The determination of whether to request and store the new file or store only the reference file may be made based on one or more storage policies. For example, the determination may be based on the storage policy associated with the computing device which requested the file.

In an operation 13, a computing device may receive input related to storing a new a file at the computing device. For example, a second computing device 200 may receive input relating to storing a new file locally in a second non-transitory storage device 210 of the second computing device 200. The input may comprise, for example, the new file, a location in the reference directory 220 at which to store the new file, and/or other information related to the new file. The second computing device 200 may store the new file in the second non-transitory storage device 220.

In an operation 14, the second computing device 200 may also generate a new reference file corresponding to the new file. The second computing device 200 may store the new reference file and an association between the new file and the new reference file in the second non-transitory storage device 220.

In an operation 15, the second computing device 200 may add a new file representation corresponding to the new file to the second reference directory 220 of the second computing device 200. The new file representation may be added at the location specified in the information received relating to the new file. The new file representation may comprise the new file.

In an operation 16, the second computing device 200 may propagate information relating to the new file to the other computing devices of the set of computing devices. The information may comprise, for example, a reference file for the new file, a location of the new file in the second reference directory 220, and/or other information related to the new file. In some implementations, the information may also comprise the new file. In some implementations, the second computing device 200 may send the information to the home computing device 100, which may then propagate the information to other computing devices. In some implementations, the second computing device 200 may send the information to each of the other computing devices in the set of computing devices.

In some implementations, the third computing device 300 may receive the information relating to the new file. The third computing device 300 may decide to save the new file to the third non-transitory storage device 320, or may decide to save only the new reference file to the non-transitory storage device 320. The reference file may be received from the home computing device 100, the computing device that generated the new file, and/or other computing device in the set of computing devices. The given computing device may determine whether to download the new file by transmitting a request that includes the reference file to one or more computing devices in the set or simply store the reference file only (which may be used to later obtain the new file on demand).

The determination of whether to store the new file or store only the reference file may be made based on the storage policy associated with the third computing device 300. For example, the storage policy of the third computing device 300 may comprise a third set of rules regarding the data that may be stored locally at the third non-transitory storage device 320.

Responsive to the new file complying with the third set of rules and in implementations in which the information relating to the new file comprised the new file, the new file may be stored locally at the third computing device 300. Responsive to the new file complying with the third set of rules and in implementations in which the information relating to the new file did not comprise the new file, the third computing device 300 may request the new file in a manner similar to accessing the new file based on the new reference file. Responsive to receiving the new file, the new file may be stored locally at the third computing device 300. A new file representation comprising the new file may be included in the directory at a location corresponding to the location specified in the information received relating to the new file.

Responsive to the new file not complying with the third set of rules, the new reference file may be stored locally at the third computing device 300. The new file representation may comprise the new file reference.

FIGS. 12A, 12B, and 12C illustrate a block diagram of an exemplary reference directory of a home computing device, second computing device, and third computing device, according to various implementations of the invention. For example, FIGS. 12A, 12B, and 12C illustrate the reference directories 120, 220, and 320 after the addition of the file F4 to the second computing device 200 is propagated to each of the other computing devices in the set of computing devices.

A computing device (e.g., computing device 100, 200, 300, . . . , n) may be any computing device such as, for example, a server, a desktop computer, laptop computer, personal digital assistant, smart phone, and/or any other computing device. Other configurations and system architectures may be used. For example, although not shown, computing device may be or include one or more servers connected to one or more clients via a network 20 such as a Wide Area Network, Local Area Network, the Internet, a cloud-based network and/or other network or combination thereof. The computing device may be capable of communicating with network 20, other computing devices in the set of computing devices, cloud storage devices, and/or other devices.

The computing device may facilitate communication with the other computing device. For example, a user may communicate with the computing device 100 via for example, one or more LCD displays, a keyboard, a touch pad, a mouse, a printer, one or more devices required for authentication purposes (e.g., CAC reader, fingerprint scanner, and/or other biometric authenticating devices), a web camera, one or more USB devices, and/or other devices used for data communication with the computing device.

In some implementations, one of the computing devices of the set of computing devices may be a server and/or other computing device associated with an online content provider (e.g., YOUTUBE, a mobile application store, and/or other online content provider). In these implementations, the computing device associated with the content provider may not update its reference directory in response to changes in content of other computing devices in the set of computing devices that are not associated with the content provider. In some implementations, a first computing device of the set of devices may be associated with a first content provider and a second computing device of the set of computing devices may be associated with a second content provider, while a third computing device, fourth computing device, and fifth computing device may be associated with respective individual users. In some implementations, the first computing device may not update its reference directory in response to changes in content of any of the other computing devices. In some implementations, the first computing device may update its reference directory in response to changes in content of the computing devices associated with individual users (e.g., the third computing device, fourth computing device, and fifth computing device), but not in response to changes in content at computing devices associated with other content providers (e.g., the second computing device). In some implementations, the first computing device may update its reference directory in response to changes in content in any of the computing devices in the set of computing devices listed in a list of related computing devices stored in the first non-transitory storage device of the first computing device. In some implementations, the first computing device may update its reference directory in response to changes in content in any of the other computing devices.

Anon-transitory electronic storage device (e.g., storage device 110, 210, 310, etc.) may be at least one database that stores system data such as profile information for the registered users, delivery specifications associated with one or more registered users, or any other data. The non-transitory electronic storage device may be associated and communicate with the computing device 100.

The one or more databases comprising the non-transitory electronic storage may be, include, or interface to, for example, an Oracle™ relational database sold commercially by Oracle Corporation. Other databases, such as Informix™, DB2 (Database 2) or other data storage, including file-based, object, or query formats, platforms, or resources such as OLAP (On Line Analytical Processing), SQL (Standard Query Language), NoSQL, a SAN (storage area network), Microsoft Access™ or other form of database may also be used, incorporated, or accessed. The database may comprise one or more such databases that reside in one or more physical devices and in one or more physical locations. The database may store a plurality of types of data and/or files and associated data or file descriptions, administrative information, or any other data.

In some implementations, each non-transitory electronic storage device may be part of or hosted by a computing device on the network 20, one of the computing devices of the set of computing devices, a cloud storage device, and/or other device. In some implementations, the non-transitory electronic storage device may be physically separate from the computing device but may be operably communicable therewith.

In some implementations, the non-transitory electronic storage device may comprise electronic storage media that electronically stores information. The non-transitory electronic storage device may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The non-transitory electronic storage device may include one or more virtual storage resources (e.g., cloud storage, a virtual private network, and/or other virtual storage resources). The non-transitory electronic storage device may store software algorithms, information determined by one or more physical processors of one or more of the set of computing devices, information received from one or more of the set of computing devices, information received from third parties, and/or other information that enables the computing device to function as described herein.

The processor(s) (e.g., processors 130, 230, 330, etc.) is configured to provide information processing capabilities in computing device 100. As such, the processor may include one or more of a digital processor, an analog processor, a digital circuit designed to process information, an analog circuit designed to process information, a state machine, and/or other mechanisms for electronically processing information. Although the processor is shown in FIG. 1 as a single entity in an individual computing device, this is for illustrative purposes only. In some implementations, processor may include a plurality of processing units. These processing units may be physically located within the same device, or the processor may represent processing functionality of a plurality of devices operating in coordination. The processor 101 may be programmed to execute computer readable instructions to cause the computing device to perform specific functionality. The processor may be programmed to execute computing readable instructions to cause the computing device to perform specific functionality by software; hardware; firmware; some combination of software, hardware, and/or firmware; and/or other mechanisms for configuring processing capabilities on processor 101.

In addition, implementations of the invention may be made in hardware, firmware, software, or any suitable combination thereof. Aspects of the invention may also be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Further, firmware, software, routines, or instructions may be described herein in terms of specific exemplary aspects and implementations of the invention, and performing certain actions. However, it will be apparent that such descriptions are merely for convenience and that such actions in fact result from computing devices, processors, controllers, or other devices executing the firmware, software, routines, or instructions.

Aspects and implementations described herein as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other aspects or implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A method for remotely retrieving content regardless of its location by a first content ID reproducibly identifying the content and being calculated from the content using a first algorithm, wherein the method being implemented in a first computing device which stores a first reference file containing the first content ID, and the method comprising:
retrieving the first content ID from the first reference file;
sending a content request containing the first content ID to at least one of remote computing devices communicably coupled to the first computing device; and
obtaining the content corresponding to the first content ID from at least one of the requested remote computing devices; and
wherein the reference file contains a first file type identifier, and the first computing device performs the method to process the first reference file according to the first file type identifier.

2. The method according to claim 1, wherein the first reference file further comprising a second file type identifier corresponding to a computer program for processing the content corresponding to the first content ID, and the method further comprising:
retrieving the second file type identifier from the first reference file for the first computing device to launch the computer program to process the obtained content.

3. The method according to claim 1, further comprising:
generating a first file containing the received content; and
replacing the first reference file stored in the first computing device with the generated first file.

4. The method according to claim 1, wherein a second file containing second file content is stored in the first computing device, and the method further comprising:
generating a second content ID that reproducibly identifies the second file content regardless of lacking knowledge of the second file's location;
sending a confirmation request including the second content ID to at least one of the remote computing devices for determining whether at least one of the requested remote computing devices stores a file containing the second file content;
generating a second reference file containing the second content ID responsive to a confirmation corresponding to the confirmation request is received;
replacing the second file stored in the first computing device with the generated second reference file.

5. The method according to claim 1, wherein the content is obtained at the first computing device by:
receiving from at least one of the requested computers information related to a set of content portions, and wherein the set of content portions constitutes the content corresponding to the first content ID;
receiving the content portions from one or more of the requested remote computers;
combining the content portions to obtain the content corresponding to the first content ID according to the received information.

6. The method according to claim 1, wherein the first algorithm is a hash function that generates a have value as the first content ID from the content.

7. A system for remotely retrieving content regardless of its location by a first content ID reproducibly identifying the content and being calculated from the content using a first algorithm, the system being implemented in a first computing device which stores a first reference file containing the first content ID, and the system comprising:
a reference file opener for retrieving the first content ID from the first reference file and sending a content request containing the first content ID to at least one of remote computing devices communicably coupled to the first computing device to obtain the content corresponding to the first content ID; and
wherein the first reference file contains a first file type identifier, and the first computing device launches the reference file opener for processing the first reference file according to the first file type identifier.

8. The system according to claim 7, wherein the first reference file further comprising a second file type identifier corresponding to a computer program for processing the content corresponding to the first content ID, and the system further comprising:
an application launcher for retrieving the second file type identifier from the first reference file to launch the computing program to process the obtained content.

9. The system according to claim 7, further comprising:
a file manager for generating a first file containing the received content and replacing the first reference file stored in the first computing device with the generated first file.

10. The system according to claim 7, wherein a second file containing second file content is stored in the first computing device, and the system further comprising:
an identification generator for generating a second content ID that reproducibly identifies the second file content regardless of lacking knowledge of the second file's location;
a file packager for creating a second reference file containing the second content ID and the first file type identifier according to which a computing device to launch a computer program to process the second reference file; and
wherein the file manager further determines whether at least one of the remote computing devices stores a file containing the second file content by sending a confirmation request including the second content ID to the at least one of remote computers and replaces the second file in the first computing device with the generated second reference file after receiving a confirmation in response to the confirmation request.

11. The system according to claim 7, wherein:
the reference file opener further receives from at least one of the requested computers information related to a set of content portions, and wherein the set of content portions constitutes the content corresponding to the first content ID; and
the reference file opener further receives the content portions from one or more of the requested remote computers and combines the content portions to obtain the content corresponding to the first content ID according to the information.

12. The system according to claim 7, wherein the first algorithm is a hash function that generates a hash value as the first content ID from the content.

13. The system according to claim 8, wherein the second file type identifier is a file extension in the name of the first reference file, and the application launcher further retrieves the second file type identifier from the name of the reference file.

14. The system according to claim 7, wherein the first reference file further comprises metadata corresponding to a file containing content corresponding to the first content ID, and the system further comprising:
a metadata presenter for retrieving said metadata to be displayed by the first computing device.

15. The system according to claim 14, wherein the metadata includes a thumbnail generated from the first file content.

16. A method for distributing first file content of a first file stored in a first computing device, the method comprising:
generating a first content ID that reproducibly identifies the first file content regardless of lacking knowledge of the first file's location;
creating a first reference file including the first content ID and a first file type identifier; and
wherein a second computing device receiving and opening the first reference file according to the first file type identifier sends a content request containing the first content ID for the first file content to at least one of computing devices communicably coupled to the second computing device and obtains the first file content from at least one of the requested computing devices.

17. The method according to claim 16, wherein the first content ID of the first reference file is a hash value generated by a hash function.

18. The method according to claim 16, wherein the first reference file further comprises a second file type identifier corresponding to an computer program to be launched by the second computing device to process of the first file content.

19. The method according to claim 16, wherein the first file is stored in a first file directory, and the method further comprising:
generating a first directory identifier from the first content ID;
storing the first directory identifier in the first reference file; and
wherein the second computing device receiving and opening the first reference file generates a second file containing the first file content upon receiving the first file content as a response to the content request, and generates a second file directory containing the generated second file according to the first directory identifier.

20. A system for distributing file content implemented in a first computing device storing a first file containing first file content, the system comprising:
an identification generator for generating a first content ID that reproducibly identifies the first file content regardless of lacking knowledge of the first file's location;
a file packager for creating a first reference file including the first content ID and a first file type identifier; and
wherein a second computing receiving and opening the first reference file according to the first file type identifier sends a content request containing the first content ID for first the file content to at least one of computing devices communicably coupled to the second computing device including the first computing device and obtains the first file content from at least one of the requested computing devices.

21. The system according to claim 20, wherein the identification generator further comprising a hash function for generating a hash value from the first file content as the first content ID of the first reference file.

22. The system according to claim 20, wherein the file packager further stores as a portion of the first reference file a second file type identifier corresponding to a computer program for the second computing device to launch for processing of the first file content.

23. The system according to claim 22, wherein the second file type identifier is a file extension in the name of the first reference file.

24. The system according to claim 20, wherein the file packager further generates metadata of the first file based on the content of the first file and stores the metadata in the reference file.

25. The system according to claim 24, wherein the metadata includes a thumbnail generated from the first file content.
